(19) United States
(12) Patent Application Publication
(10) Pub. No.: US 2011/0073343 A1
(43) Pub. Date: Mar. 31, 2011

(54) Electric power tool

(75) Inventors: Fumiaki Sawano, Hikone (JP); Hidenori Shimizu, Hikone (JP); Hiroshi Miyazaki, Hikone (JP)

(73) Assignee: Panasonic Electric Works Power Tools Co., Ltd., Hikone (JP)

(21) Appl. No.: 12/923,418

(22) Filed: Sep. 21, 2010

(30) Foreign Application Priority Data
Sep. 25, 2009 (JP) 2009-221496

(51) Int. Cl. B25F 5/00

(52) U.S. Cl. 173/217

(57) ABSTRACT

An electric power tool includes a housing, a motor arranged within the housing, a power transmission unit arranged within the housing for transferring rotation of the motor to a work tool, a motor control unit arranged within the housing for controlling the rotation of the motor, and a trigger switch retractably provided to the housing for instructing the motor control unit to control the rotation of the motor. The electric power tool further includes a wireless communication device arranged within the housing for wirelessly communicating the work information on the content of works. The wireless communication device includes an antenna unit. The wireless communication device is covered with a shock-absorbing material. The antenna unit is arranged to lie higher than the trigger switch when the electric power tool is stored in a specified storage state.

### FIELD OF THE INVENTION

The present invention relates to an electric power tool having a wireless communication function by which the work information on the content of works can be wirelessly communicated between the electric power tool and the outside.

### BACKGROUND OF THE INVENTION

Conventionally, there is proposed an electric power tool that includes, as shown in FIG. 4, a housing 10 and a wireless communication device 24 arranged inside the housing 10, the wireless communication device 24 having an antenna unit 30a for transmitting information, e.g., the fastening torque, to a controller for managing a screw tightening work, only the antenna unit 30a being arranged outside the housing (see, e.g., Japanese Patent Application Publication No. H06-312381).

Also proposed is an electric power tool that includes, as shown in FIG. 5, a housing 10 and a wireless communication device 24 arranged inside the housing 10, the wireless communication device 24 having an antenna unit 30a stored in a rack 21 arranged outside the housing 10 (see, e.g., Japanese Patent Application Publication No. 2008-213069).

With the electric power tools cited above, there is a likelihood that the wireless communication device arranged inside the housing may collide with the surrounding structures due to the vibration generated during works and may eventually be broken. In addition, the electric power tools suffer from a problem in that those foreign materials such as iron particles or the like may accumulate on the antenna unit when the antenna unit is stored at the end of works, which may attenuate radio waves.

### SUMMARY OF THE INVENTION

In view of the above, the present invention provides an electric power tool capable of preventing a wireless communication device from being broken due to the collision with the surrounding structures otherwise caused by vibration and also capable of preventing foreign materials such as iron particles or the like from accumulating on an antenna unit.

In accordance with an embodiment of the present invention, there is provided an electric power tool, including: a housing; a motor arranged within the housing; a power transmission unit arranged within the housing for transferring rotation of the motor to a work tool; a motor control unit arranged within the housing for controlling the rotation of the motor; a trigger switch provided to the housing for instructing the motor control unit to control the rotation of the motor; and a wireless communication device arranged within the housing for wirelessly communicating the work information on the content of works, the wireless communication device including an antenna unit, wherein the wireless communication device is covered with a shock-absorbing material, the antenna unit being arranged to lie higher than the trigger switch when the electric power tool is stored in a specified storage state.

With such configuration, by covering the wireless communication device with the shock-absorbing material, it becomes possible for the shock-absorbing material to reduce the shock applied to the wireless communication device when the latter collides with the surrounding structures due to the vibration generated during works. Further, since the antenna unit is arranged within the housing to lie higher than the trigger switch when the electric power tool is stored in a specified storage state, it is possible to prevent foreign materials, such as iron particles or the like, that have infiltrated through the gap between the trigger switch and the housing from accumulating on the antenna unit.

The specified storage state may be a state in which the electric power tool is stored in a tool folder such that an output portion thereof for holding the work tool faces obliquely downwards.

The present electric power tool can prevent the wireless communication device from being broken due to the collision with the surrounding structures otherwise caused by vibration and can also prevent those foreign materials such as iron particles or the like from accumulating on the antenna unit.

### BRIEF DESCRIPTION OF THE DRAWINGS

The objects and features of the present invention will become apparent from the following description of embodiments, given in conjunction with the accompanying drawings, in which:

FIG. 1 is a schematic explanation view showing an electric power tool in accordance with one embodiment of the present invention;

FIG. 2 is a schematic configuration view showing a wireless communication device employed in the electric power tool;

FIG. 3 is a schematic explanation view showing the electric power tool which is being stored out of works;

FIG. 4 is a side view illustrating a conventional electric power tool; and

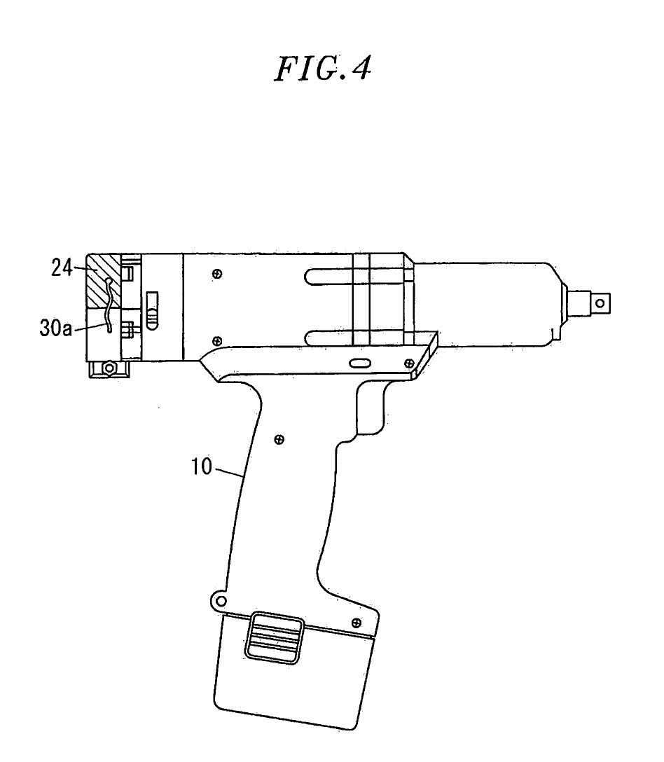

FIG. 5 is a side view illustrating another conventional electric power tool.

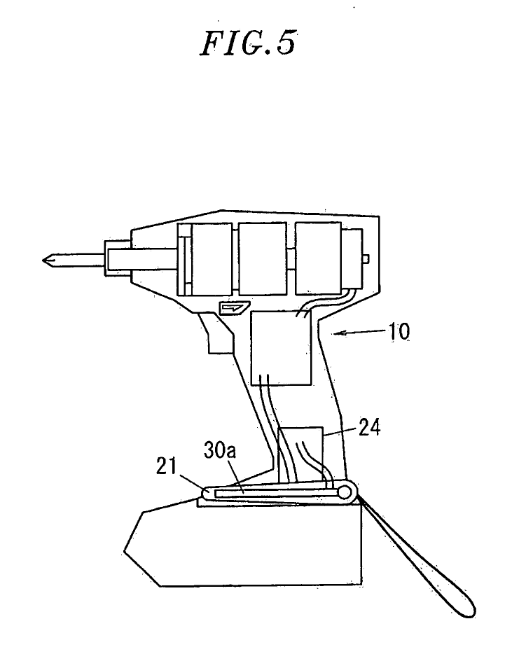

### DETAILED DESCRIPTION OF THE PREFERRED EMBODIMENTS

One embodiment of an electric power tool in accordance with the present invention will now be described with reference to the accompanying drawings which form a part hereof.

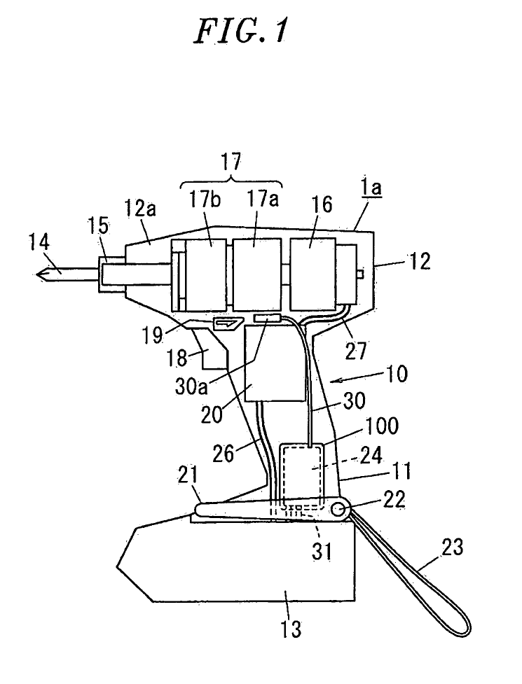

Referring to FIG. 1, an electric power tool 1a includes a hollow tubular grip 11 formed into a hand-held size and a hollow tubular body 12 provided at one axial end (upper end) of the grip 11. The body 12 has an axis intersecting the axis of the grip 11 so that the body 12 and grip 11 can make a substantially “T”-shape when seen in a side view. The electric power tool 1a further includes a battery holder 13 provided at the other axial end (lower end) of the grip 11. The grip 11, the body 12 and the battery holder 13 make up a housing 10 of the electric power tool 1a. A rechargeable battery (not shown) is accommodated within the battery holder 13 removably attached to the lower end portion of the grip 11. Electric power for operation of the electric power tool 1a is supplied from the rechargeable battery to a motor control unit 20 and a wireless communication device 24, which will be described later, through power cords 26 and 31 respectively. Alternatively, the battery holder 13 may be integrally formed with the lower end portion of the grip 11.

A metal-made cover 12a is arranged at one axial end (front end) side of the body 12. Also arranged at the front end side of the body 12 is a metal-made chuck 15 to which a work tool (bit) 14 such as a driver bit or a socket is attached in a removable manner. The chuck 15 is rotationally driven about the axis of the body 12 by a motor 16 arranged at the other end (rear end) side of the body 12. The rotational drive force of the motor 16 is transferred to the chuck 15 through a power transmission unit 17 built in the body 12.

The power transmission unit 17 includes a speed reducer 17a connected at one end (rear end) to the motor 16 and an impact generating unit 17b connected to the other end (front end) of the speed reducer 17a. The rotational movement of the motor 16 is transferred at a reduced speed to the chuck 15 through the speed reducer 17a and the impact generating unit 17b. The speed-reduced rotational movement of the motor 16 is merely transferred to the chuck 15 insofar as the load applied to the chuck 15 is smaller than or equal to a specified value. If the load applied to the chuck 15 exceeds the specified value, the impact generating unit 17b makes impact applying movement by which an impulsive rotational drive force is transferred to the chuck 15.

On the front surface of the upper end portion of the grip 11 on the side of the chuck 15, a trigger switch 18 is provided retractably in the front-rear direction. The trigger switch 18 is pressed to variably control the rotational speed of the motor 16. At the upper rear side of the trigger switch 18, a forward-reverse changeover switch 19 for changing over the rotational direction of the motor to a forward direction or a reverse direction is arranged to protrude from the surface of the body 12. The motor control unit 20 is accommodated in the inner upper portion of the grip 11 while the wireless communication device 24 is built in the inner lower portion of the grip 11.

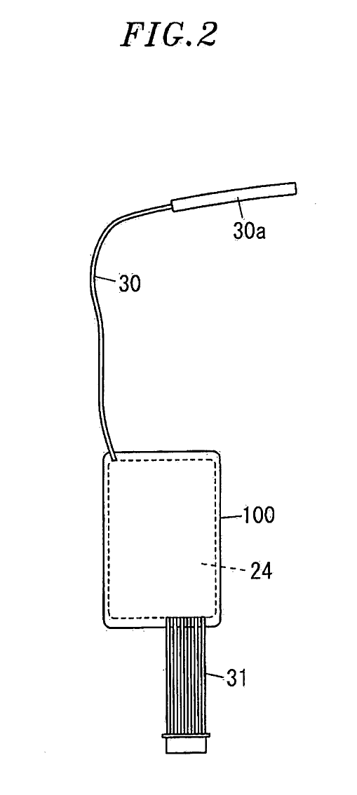

As shown in FIG. 2, a flexible antenna line 30 extends from the wireless communication device 24. At the tip end of the antenna line 30, there is arranged an antenna unit 30a for wirelessly communicating the work information on the content of works to an external management device (not shown). Since the antenna line 30 is formed into a string shape, the antenna unit 30a can be placed in any arbitrary empty position within the grip 11. The wireless communication device 24 is provided with the power cord 31 connected to the rechargeable battery lying inside the battery holder 13. Electric power for operation of the electric power tool is supplied from the rechargeable battery through the power cord 31. In the present embodiment, the antenna unit 30a is arranged in the empty position between the speed reducer 17a of the power transmission unit 17 and the motor control unit 20 as shown in FIG. 1.

The wireless communication device 24 except those portions connected to the antenna line 30 and the power cord is fully covered with a shock-absorbing material 100. This makes it possible for the shock-absorbing material 100 to reduce the shock applied to the wireless communication device 24 when the latter collides with the surrounding structures due to the vibration generated during works. Thus, the shock-absorbing material 100 protects the wireless communication device 24 from breakage.

A rack 21 is pivotally attached to the lower rear portion of the outer surface of the grip 11 so that it can rotate about a pivot shaft 22 in the front-rear direction. The rack 21 is in the shape of a rod and is pivotally supported at one end thereof by the pivot shaft 22 so that it can rotate from an angular position substantially perpendicular to the axial direction of the grip 11 to an angular position substantially parallel to the axial direction of the grip 11.

A loop-shaped drop preventing strap 23 is attached to the lower rear portion of the grip 11.

The on/off operation and rotation speed of the motor 16 are controlled by the motor control unit 20. Depending on the retraction amount of the trigger switch 18 and responsive to the instruction of the trigger switch 18 to control the rotation speed of the motor 16, the motor control unit 20 controls the motor 16. In addition, the motor control unit 20 can change the direction of rotation of the motor 16 in response to the instruction of the forward-reverse changeover switch 19, thereby determining whether to tighten or loosen a screw. The motor control unit 20 and the motor 16 are connected to each other by a connection line 27 so that the motor control unit 20 can control the motor 16 through the connection line 27. Although not shown in the drawings, the motor control unit 20 is also connected to the trigger switch 18 and the forward-reverse changeover switch 19 so that it can control an output of the motor 16 in response to the signals inputted from the trigger switch 18 and the forward-reverse changeover switch 19.

In the electric power tool 1a, the wireless communication device 24 transmits the work information on the content of works, such as the fastening torque, the number of screws tightened, the work time and the remaining battery level, to the external management device through the antenna unit 30a.

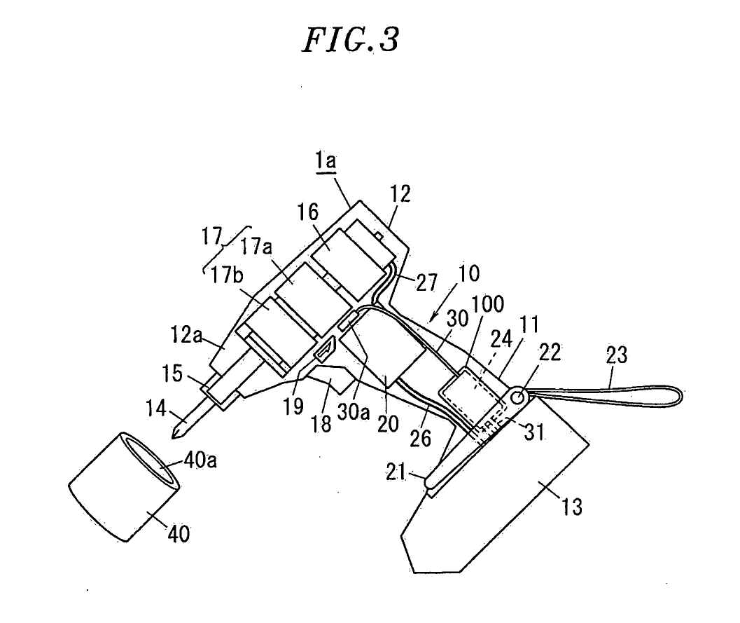

When not in use, e.g., when a series of works is stopped or come to an end, the electric power tool 1a is held in a job-site tool folder 40 in a specified storage state, namely in such a state that the front portion of the body 12 of the electric power tool 1a (the output portion in which the chuck 15 is arranged) is inserted into a holding hole 40a of the tool folder 40 in a downwardly inclined posture (see FIG. 3).

As described above, the antenna unit 30a is arranged in the empty position between the speed reducer 17a of the power transmission unit 17 and the motor control unit 20.

As shown in FIG. 3, the antenna unit 30a is positioned higher than the trigger switch 18 when the electric power tool 1a is kept in the specified storage state. Accordingly, when electric power tool 1a is kept in a downwardly inclined state, it is possible to prevent foreign materials, such as iron particles or the like, that have infiltrated through the gap between the trigger switch 18 and the housing 10 from accumulating on the antenna unit 30a. This makes it possible to avoid the problem of radio waves being attenuated and data transmission being hindered by the foreign materials such as iron particles otherwise accumulated on the antenna unit 30a.

While the electric power tool of the present embodiment described above includes the housing 10 in which the grip 11 and the body 12 make a substantially “T”-shape when seen in a side view, it is needless to say that the present invention may be applied to an electric power tool including a substantially “I”-shaped housing in which the body 12 and the grip 11 are arranged along a straight line. Although an impact driver has been described as an example of the electric power tool in the present embodiment, the electric power tool may be the one having other functions, e.g., an oil pulse impact driver or a driver with no impact function.

While the invention has, been shown and described with respect to the embodiments, it will be understood by those skilled in the art that various changes and modification may be made without departing from the scope of the invention as defined in the following claims.

What is claimed is:

1. An electric power tool, comprising:
a housing;
a motor arranged within the housing;
a power transmission unit arranged within the housing for transferring rotation of the motor to a work tool;
a motor control unit arranged within the housing for controlling the rotation of the motor;
a trigger switch provided to the housing for instructing the motor control unit to control the rotation of the motor; and
a wireless communication device arranged within the housing for wirelessly communicating the work information on the content of works, the wireless communication device including an antenna unit,
wherein the wireless communication device is covered with a shock-absorbing material, the antenna unit being arranged to lie higher than the trigger switch when the electric power tool is stored in a specified storage state.

2. The electric power tool of claim 1, wherein the specified storage state is a state in which the electric power tool is stored in a tool folder such that an output portion thereof for holding the work tool faces obliquely downwards.
